(19) United States
(12) Patent Application Publication
(10) Pub. No.: US 2008/0017606 A1
(43) Pub. Date: Jan. 24, 2008

(54) METHOD OF FORMING STRUCTURE, BANK STRUCTURE, ELECTRONIC CIRCUIT, ELECTRONIC DEVICE AND ELECTRONIC APPARATUS

(75) Inventors: Shunpu LI, Cambridge (GB); Christopher NEWSOME, ST. NES (GB); Daping CHU, Cambridge (GB)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/778,889

(22) Filed: Jul. 17, 2007

(30) Foreign Application Priority Data
Jul. 18, 2006 (JP) 2006-195190

(51) Int. Cl. B41J 2/01

(52) U.S. Cl. 216/13; 216/54

(57) ABSTRACT

A method for forming a surface energy difference bank includes: providing a material for forming a self-assembled molecular film onto a contact region of a stamps the contact region being formed of a plurality of apical faces of a plurality of elastic elements protruding out from a base part of the stamp; and transferring the material from the contact region to an object face by contacting the contact region with the object face so as to obtain the surface energy difference bank that is composed of a plurality of dots on the object face, the plurality of the dots being made of the self assembled molecular film and corresponding to the plurality of elastic elements.

### BACKGROUND OF THE INVENTION

1. Technical Field

Several aspects of the present invention relate to a method for forming a surface energy difference bank, method for forming a pattern, a bank structure, an electronic circuit, an electronic device and an electronic apparatus.

2. Related Art

Photolithography technique has been generally used as one of common patterning methods for manufacturing an electronic device. Alternatively, an ink-jet printing technique which does not require exposure process has recently started to be used. Where a high-resolution patterning is performed by the ink-jet printing, a technique in which a bank structure (a surface energy difference bank) having a surface energy difference is formed so as to enclose ink has been known. With such technique, it is possible to increase the resolution of the patterning.

JP-A-2005-4091 is an example of related art. The example discloses one of methods for forming a high-resolution thin film pattern such as the above-mentioned surface energy difference bank is a micro-contact printing (μCP) or a soft-contact printing. The micro-contact printing is a technique that uses a stamp having a desired pattern to transfer the thin film pattern on a substrate by contacting the stamp with the substrate.

However, according to the hitherto know micro-contact printing, it is difficult to bring the whole contacting area of the stamp to uniformly contact with an uneven surface in order to make a surface energy difference bank.

### SUMMARY

An advantage of the invention is to provide a method manufacturing a surface energy difference bank. The bank made of a self-assembled molecular film can be uniformly formed on an uneven surface of an object by the micro-contact printing.

I. A method for forming a surface energy difference bank according to a first aspect of the invention includes providing a material for forming a self-assembled molecular film onto a contact region of a stamp, the contact region being formed of a plurality of apical faces of a plurality of elastic elements protruding out from a base part of the stamp, and transferring the material from the contact region to an object face by contacting the contact region with the object face so as to obtain the surface energy difference bank that is composed of a plurality of dots on the object face, the plurality of the dots being made of the self-assembled molecular film and corresponding to the plurality of elastic elements.

According to the first aspect of the invention, the contact region of the stamp is formed of the plurality of the apical faces of the plurality of the elastic elements protruding out from the base part of the stamp. Each of the elastic elements is deformable irrespective of the degree of flatness of the object face. The material of the self-assembled molecular film is provided onto such contact region of the stamp and the contact region is contacted with the object face. Thereby, it is possible to form the surface energy difference bank made of the self-assembled molecular film on the object face regardless of the degree of flatness of the object face.

II. In this case, the object face may have an uneven surface, and each of the plurality of the elastic elements may deform according to the object face so as to fit the whole of the contact region with the object face substantially.

In this way, even if the object face does not have a flat surface, the plurality of the elastic elements can deform according to the figure of the object face and the plurality of the elastic elements can contact with the object face. Accordingly, it is possible to form the surface energy difference bank made of the self-assembled molecular film on the uneven object face.

III. In this case, the plurality of the apical faces may be arranged in such a way that the plurality of the dots formed on the object face prevents a functional liquid from flowing over the plurality of the dots.

In this way, the plurality of the apical faces is arranged in such a way that the plurality of the dots formed on the object face prevents a functional liquid from flowing over the plurality of the dots. Thereby it is possible to prevent overflow of the functional liquid and generation of bridges if the functional liquid is provided onto the area surrounded by these surface energy difference banks by the ink-jet printing method.

IV. In this case, the plurality of the apical faces may be arranged so as to form lines.

In this way, the plurality of the apical faces may be arranged so as to form lines, and each line can prevent the functional liquid from flowing out. Thereby, it is possible to prevent the functional liquid from flowing over the plurality of the dots.

V. It is preferable that the apical faces be arranged in a predetermined pitch in each of the lines, and any two adjacent lines among the lines be arranged such that the two lines are out of alignment each other by substantially a half of the predetermined pitch in a column-direction in which the lines extend.

In this way, dots formed on the object face are arranged such that a dot in a line faces a gap between two adjacent dots in the next line. Thereby, even if the functional liquid flows over the gap between the dots in one line, the dot in the next line can prevent the functional liquid from further flowing. Therefore, it is possible to effectively prevent the flowing out of the functional liquid across the dots.

VI. In this case, the self-assembled molecular film may be more liquid-repellent than the object face.

The functional liquid is less disposed on an area where is liquid-repellent but more easily disposed on other area where is not liquid-repellent. Therefore, it is possible to hold the functional liquid which is provided by an ink-jet printing method within the area defined by the surface energy difference bank made of the self-assembled molecular film.

VII. The self-assembled molecular film may be more hydrophilic than the object face.

VIII. A method for forming a surface energy difference bank according to a second aspect of the invention includes providing a material for forming a self-assembled molecular film onto a contact region of a stamp, the contact region being formed of a plurality of apical faces of a plurality of elastic elements protruding out from a base part of the stamp; transferring the material from the contact region to an object face by contacting the contact region with the object face so as to obtain the surface energy difference bank that is composed of a plurality of dots on the object face, the plurality of the dots being made of the self-assembled molecular film and corresponding to the plurality of elastic elements; and forming a pattern containing a predetermined material in an area where is defined by the surface energy difference bank by providing a functional liquid containing the predetermined material onto the area.

According to the second aspect of the invention, the contact region of the stamp is formed of the plurality of the apical faces of the plurality of the elastic elements protruding out from the base part of the stamp. Each of the elastic elements is deformable irrespective of the degree of flatness of the object face. The material of the self-assembled molecular film is provided onto such contact region of the stamp and the contact region is transferred to the object face. Thereby, the surface energy difference bank made of the self-assembled molecular film can be uniformly formed throughout the object face. The functional liquid is provided in an area surrounded by such surface energy difference banks so that a fine pattern can be obtained from the functional liquid.

IX. A bank structure according to a third aspect of the invention is manufactured by a manufacturing method including providing a material for forming a self-assembled molecular film onto a contact region of a stamp, the contact region being formed of a plurality of apical faces of a plurality of elastic elements protruding out from a base part of the stamp; and transferring the material from the contact region to an object face by contacting the contact region with the object face so as to obtain the surface energy difference bank that is composed of a plurality of dots on the object face, the plurality of the dots being made of the self-assembled molecular film and corresponding to the plurality of elastic elements.

X. An electronic circuit according to a fourth aspect of the invention includes the above-mentioned bank structure and at least one of a conductive pattern, a ferroelectric pattern, a semiconductor pattern, a dielectric pattern or an electric light emitting pattern which is formed in the area defied by the surface energy difference bank.

XI. An electronic device according to a fifth aspect of the invention includes the above-mentioned bank structure and at least one of a conductive pattern, a ferroelectric pattern, a semiconductor pattern, a dielectric pattern or an electric light emitting pattern which is formed in the area defied by the surface energy difference bank.

XII. An electronic apparatus according to a sixth aspect of the invention includes the above-mentioned bank structure and at least one of a conductive pattern, a ferroelectric pattern, a semiconductor pattern, a dielectric pattern or an electric light emitting pattern which is formed in the area defied by the surface energy difference bank.

### BRIEF DESCRIPTION OF THE DRAWINGS

The invention will be described with reference to the accompanying drawings, wherein like numbers reference like elements.

FIG. 1 schematically shows a structure of a stamp according to an embodiment of the invention

FIG. 2 is a plane view from the side II in FIG. 1.

FIGS. 3A and 3B are explanatory drawings schematically showing how to form a surface energy difference bank according to an embodiment.

FIG. 4 is an explanatory drawing schematically showing how to form the surface energy difference bank seeing from the side IV in FIG. 3A.

FIGS. 5A and 5B schematically show a method for forming a pattern according to an embodiment.

FIGS. 6A through 6D schematically show a method for manufacturing a stamp according to an embodiment.

FIGS. 7A through 7E schematically show a method for manufacturing a stamp according to an embodiment.

FIGS. 8A through 8D schematically show a method for manufacturing a stamp according to an embodiment.

FIGS. 9A and 9B show an electronic apparatus according to an embodiment.

FIGS. 10A through 10C are explanatory drawings for modified examples of an arrangement of elastic elements of the stamp according to the embodiment.

### DESCRIPTION OF EXEMPLARY EMBODIMENTS

In the following embodiments, a surface energy difference bank will be formed in a part of a manufacturing process of a passive-matrix type ferroelectric memory device. It should be understood that the surface energy difference bank can be formed in a part of manufacturing process of other electronic devices in addition to the ferroelectric memory device, manufacturing process of electronic circuits or manufacturing process of electronic apparatuses.

In this description, the term “electronic device” encompasses ferroelectric memory devices, light emitting diodes, thin film transistors, electrochemical cells, photoelectric devices and the like. The word “electronic apparatus” encompasses liquid crystal display devices, plasma display devices, organic electroluminescence (EL) display devices, field emission displays (FEDs), surface-conduction electron-emitter displays (SEDs), electrophoretic display devices and the like.

Embodiments of the invention will be hereunder described with reference to the accompanying drawings. In the accompanying drawings, a scale size may be different in each component in order to make the component recognizable.

A. Stamp

Structure of a stamp which is used to form a surface energy difference bank is now described.

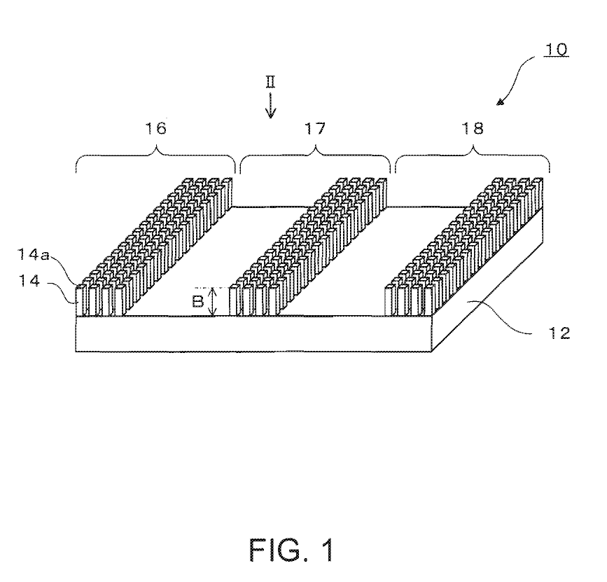

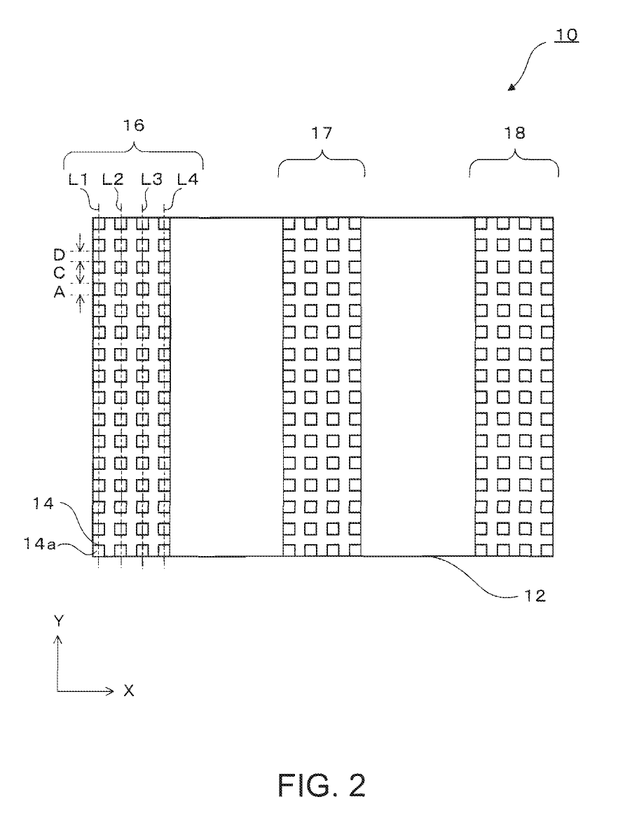

FIG. 1 schematically shows a structure of a stamp according to an embodiment. FIG. 2 is a plane view from the side II in FIG. 1.

Referring to FIG. 1, a stamp 10 has an elastic element 14 which protrudes out from a base part 12 and is provided in the plural number. Each elastic element 14 is individually deformable. The base part 12 and the elastic element 14 in the stamp 10 are made of for example poly-dimethyl-siloxane (PDMS). The base part 12 and the elastic element 14 of the stamp 10 can be any other polymers such as a mixture of trimethylsiloxy-terminated vinylmethylsiloxane-dimethylsiloxane (VDT-731) and methylhydrosiloxane-dimethylsiloxane (HMS-301) as long as it has elasticity.

The shape of an apical face 14a of each elastic element 14 is not particularly limited. The shape of the apical face 14a can be rectangle, triangle, circle, hexagon or other figures. The shape of the apical face 14a is rectangle in this embodiment. A length “A” (see FIG. 2) of one side of the apical face 14a is set within a rage of 10 nm-10 μm. An amount of protrusion “B” of the elastic element 14 from the base part 12 is set within a rage of 50 nm-10 μm.

A plurality of the apical faces 14a forms a “contact region”. In this embodiment, the plurality of the apical faces 14a forms three contact regions 16, 17, 18. The apical faces 14a are arranged so as to form lines in each of the contact regions 16, 17, 18. More specifically, the apical faces 14a are arranged such that lines L1, L2, L3, L4 that extend in Y-axis direction are formed as shown in FIG. 2. Each of the plurality of the apical faces 14a is arranged with a predetermined pitch “C” in the lines L1, L2, L3, L4. A distance “D” (D=C−A) between any two apical faces 14a is set within a range of 0.1×A−10×A.

A width of each of the contact regions 16, 17, 18 in the direction orthogonal to the direction in which the lines L1, L2, L3, L4 extend is set within a range of 10 nm-10 μm. A gap between the contact region 16 and the contact region 17 and a gap between the contact region 17 and the contact region 18 are also set within the range of 10 nm-10 μm.

A method for manufacturing the stamp will be described later.

B. Object

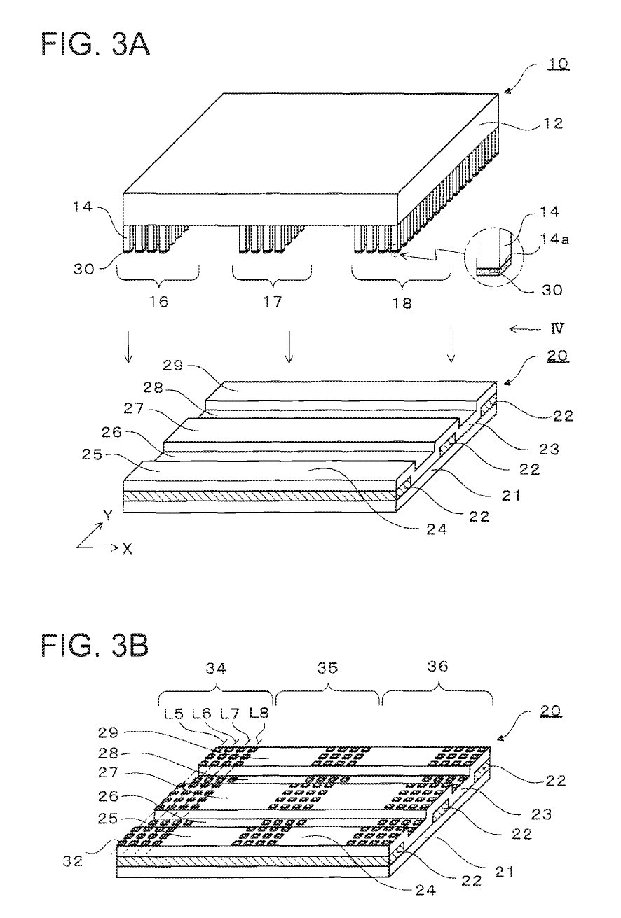

Referring now to FIG. 3A, an object 20 has a substrate 21, a lower electrode 22, a ferroelectric layer 23 and a surface layer (unshown in the drawing). The substrate 21 is required for the manufacturing of the ferroelectric memory device and is made of for example glass. The substrate 21 may be made of silicon, plastic or the like in other embodiments.

The lower electrode 22 which is provided in the plural number is formed on the substrate 21. The lower electrodes 22 extend in X-axis direction. A predetermined distance is provided between any adjacent two of the lower electrodes 22. The ferroelectric layer 23 covers the plurality of the lower electrodes 22 and the surface of the substrate 21 which is exposed among the lower electrodes 22. The surface layer covers the surface of the ferroelectric layer 23. The surface of the surface layer traces the shapes of the lower electrodes 22 which exit under the surface layer.

An “object face” in this embodiment is one like the surface of this surface layer. In other embodiments, the “object face” can be the face itself of the substrate 21, can be the surface of the ferroelectric layer or can be the surface of the plurality of the electrodes and the substrate 21. The “object face” can be flat or not flat through it is not flat in this embodiment. More specifically, the “object face” in this embodiment is the surface defined by the surface layer existing on the electrodes and the surface layer where the electrodes are not formed, and thereby the “object face” has a convex-concave figure on its surface.

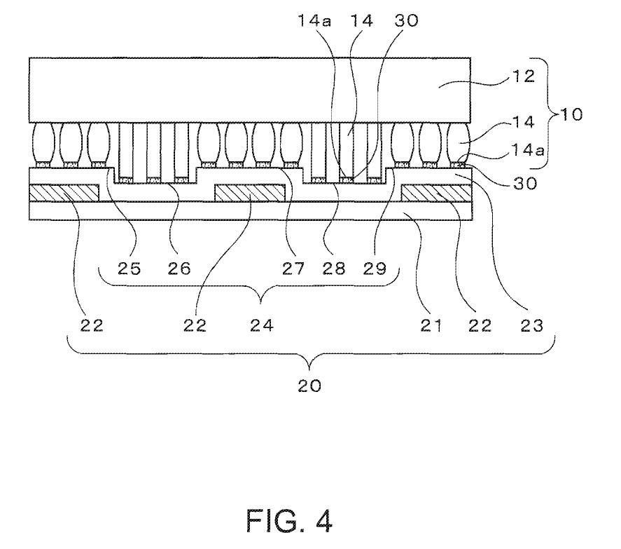

More specifically, an object face 24 is made of upper faces 25, 27, 29, bottom faces 26, 28 and side faces that connect the upper faces 25, 27, 29 respectively with the bottom faces 26, 28. Each of the upper faces 25, 27, 29 is situated at the same level from the surface of the substrate 21. The bottom faces 26, 28 are situated at the same level from the surface of the substrate 21 but which is lower than the level of the upper faces 25, 27, 29 (see FIG. 4).

C. Manufacturing Method for Ferroelectric Memory Device

C1. Example of Manufacturing Method for Object

Material containing poly-methyl-methacrylate (PMMA) is applied about 1 μm thick on the substrate 21 by a spin-coating method. The applied material is baked at 120° C. for 5 minutes to obtain a PMMA layer. The PMMA layer is then embossed by using a silicon chip. The silicon chip has a plurality of grooves, each of the grooves has a width of 10 μm and provided with a gap of 40 μm therebetween. Accordingly, a plurality of the grooves, each of which is 40 μm wide, is given to the PMMA layer.

An O₂ plasma treatment is performed to the PMMA layer so as to expose the surface of the substrate 21 at each bottom face of the grooves. The grooves are then treated by a CF₄ plasma process. This CF₄ plasma process increases a liquid-repellency of the side faces of the grooves and increases a hydrophilicity of the bottom faces of the grooves. In other words, the CF₄ plasma process generates the difference (contrast) in wettability between the side faces of the grooves (PMMA) and the bottom faces of the grooves (glass).

A silver suspension whose base is water is proved in the grooves by an ink-jet printing method. The provided suspension is then dried at 100° C. for 10 minutes to obtain silver lines. Each of the silver lines is a 100 nm thick. The remaining PMMA layer is removed with acetone. The silver lines are subsequently annealed at 150° C. for an hour. Accordingly, the plurality of the lower electrodes 22 made of the silver lines is obtained.

Copolymer of poly vinylidene fluoride and trifluoro ethylene (PVDF-TrFE) is then applied 500 nm thick on the substrate 21 and the plurality of the electrodes by the spin-coating method. The applied PVDF-TrFE copolymer is baked at 140° C. for an hour to obtain a ferroelectric layer made of the PVDF-TrFE copolymer layer. PMMA or the like is subsequently applied 50 nm thick on the obtained uneven face which is the ferroelectric layer by the spin-coating method. The applied PMMA is baked at 100° C. for 20 minutes so as to obtain the surface layer made of PMMA. The surface of the surface layer is then treated with O₂ plasma for 1 minuet.

The object 20 can be obtained in the above-described way.

C2. Method for Forming Surface Energy Difference Bank

Next, a method for forming the surface energy difference bank will be now described with reference to FIG. 3 and FIG. 4. FIGS. 3A and 3B are explanatory drawings schematically showing how to form the surface energy difference bank according to an embodiment of the invention. FIG. 4 is an explanatory drawing of the surface energy difference bank seeing from the side IV in FIG. 3A.

A material 30 for forming a self-assembled molecular film is applied onto the contact regions 16, 17, 18 which are the apical faces 14a of the elastic elements 14 protruding out from the base part 12 of the stamp 10. In this embodiment, a hexane solution containing about 0.01 mol/l of 1H, 1H, 2H, 2H-perfluoro-decyl-trichlorosilane as the material 30 is applied onto the contact regions 16, 17, 18.

In this embodiment, the degree of the liquid-repellency of the material 30 of the self-assembled molecular film is higher than that of the object face 24. The self-assembled molecular film material 30 having such repellency can be for example fluoroalkylsilane. The hydrophilicity of the self-assembled molecular film material 30 can be higher than the hydrophilicity of the object face 24 in other embodiments.

Though 1H, 1H, 9H, 2H-perfluoro-decyl-trichlorosilane is used as the material 30 in this embodiment, other materials can be also adopted instead. For example, a material composed of a molecule having —CF₃, —CH₃(CH₂)n, —NH₂, —OH or —COOH at its one end and silane or thiol at the other end depending on the type of the base surface. The solution of the molecule having —CF₃, —CH₃(CH₂)n or the like serves as the material having liquid-repellency and the solution of the molecule having —NH₂, —OH, —COOH or the like serves as the material having hydrophilicity.

The stamp 10 is pressed against the object 20 (in the direction of the arrow shown in FIG. 3) in such a way that the contact regions 16, 17, 18 of the stamp 10 contact with the object face 24 of the object 20. When the stamp 10 is pressed against the object 20, the stamp 10 is aligned with respect to the object 20 such that the direction in which the contact regions 16, 17, 18 extend orthogonally crosses the direction in which the lower electrodes 22 extend.

Referring to FIG. 4, each of the elastic elements 14 on the stamp 10 deforms according to the convex-concave figure of the object face 24. This helps the whole area of each contact region 16, 17, 18 substantially fit with the convex-concave figure of the object face 24. The upper faces 25, 27, 29 are placed closer to the base part 12 of the stamp 10 compared to the bottom faces 26, 28 in this embodiment so that the elastic elements 14 which contact with the upper faces 25, 27, 29 deform more largely that the elastic elements 14 which contact with the bottom faces 26, 28. Thereby the elastic elements 14 forming the contact region 16 for example can contact with both of the upper faces 25, 27, 29 and the bottom faces 26, 28. This feature also applies to the elastic elements 14 forming the contact region 17 and the elastic elements 14 forming the contact region 18.

In the above-described way, it is possible to contact the material 30 with areas that are situated in at least two different levels on the object face 24 such as the upper face 25 and the bottom face 26 by stamping the stamp 10 on the object face 24 for example only once. This means that the step of contacting the upper face 25 with the material 30 and the step of contacting the bottom face 26 which positions at a lower level than the upper face 25 with the material 30 can be performed at the same time.

When the material touches the object face 24, the molecules of the self-assembled molecular film material 30 and the molecules forming the object face 24 strongly bind each other and the self-assembled molecular film material 30 is transferred to the object face 24 from the contact regions 16, 17, 18.

Consequently, banks 34, 35, 36 composed of dots 32 made of the self-assembled molecular film which corresponds to the elastic elements 14 can be obtained on the object; face 24 that traces the convex-concave figure as shown in FIG. 3B. These banks 34, 35, 36 are examples of the surface energy difference bank.

In each of the banks 34, 35, 36, a plurality of dots 32 are arranged in lines L5, L6, L7, L8 which respectively correspond to the lines L1, L2, L3, L4 of the apical faces 14a. Each of the lines L5, L6, L7, L8 can control the flow of a functional liquid so that the banks 34, 35, 36 can prevent the functional liquid from flowing across the plurality of dots 32. In this way, it is possible to prevent overflow of the functional liquid and generation of bridges if the functional liquid is provided onto the area surrounded by these surface energy difference banks by the ink-jet printing method.

Accordingly, the surface energy difference bank made of the self-assembled molecular film can be uniformly formed throughout the object face 24 even if the object face 24 of the substrate is not flat.

C3. Method for Forming Upper Electrodes

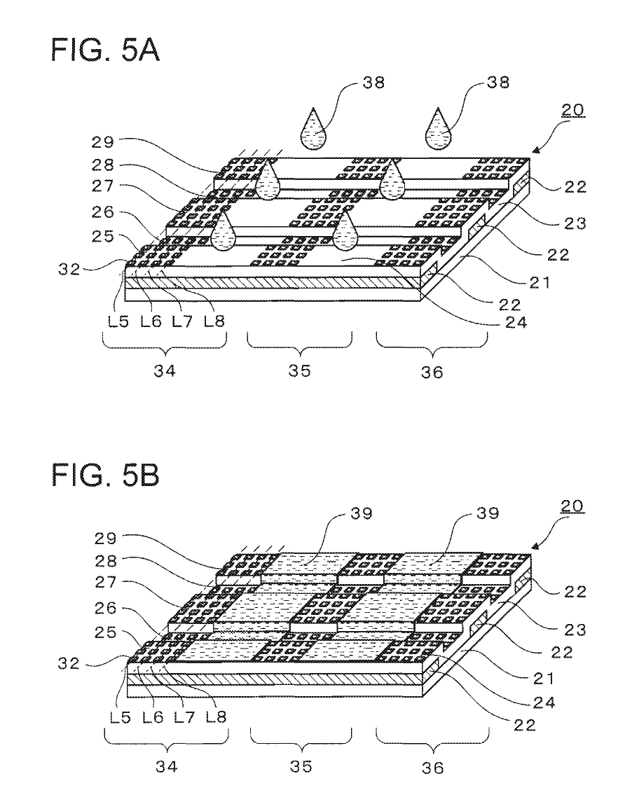

A method for forming the upper electrodes will be now described with reference to FIG. 5. Here, the upper electrodes are an example of the pattern obtained by the ink-jet printing method.

Referring to FIG. 5A and FIG. 5B, a functional liquid 39 which is a silver suspension whose base is water is proved onto the area defied by the surface energy difference banks by the ink-jet printing method. In this embodiment, the functional liquid 39 is provided by discharging a droplet 38 of the functional liquid 39 to the object face 24 that traces the convex-concave figure through an inkjet head (unshown in the drawings) having piezo elements. The provided functional liquid is then dried at 100° C. for 10 minutes. In this way, an upper electrode which extends in the substantially orthogonal direction to the direction in which the lower electrodes 22 extend and has a width of 40 μm is obtained.

The water-based colloidal silver suspension is one kind of the “functional liquid”. In this embodiment, the “functional liquid” refers to a material having a viscosity with which the material can be discharged from the nozzle in the form of the droplet 38. In this case, the “functional liquid” can be either water-based or oil-based material. It is required to have the liquidity (a low viscosity) with which the material can be discharged from the nozzle but it can contain a solid matter as long as it can serve as fluid as a whole. The viscosity of the “functional liquid” is preferably set within a range of 1-50 mPa·s. This is because where the droplet 38 of the “functional liquid” is discharged, the area around the nozzle will not be easily contaminated with the “functional liquid” if the viscosity is equal or larger than 1 mPa·s. If the viscosity is equal or smaller than 50 mPa·s, the frequency of clogging occurring at the nozzle decreases, helping the droplet 38 to be smoothly discharged.

The predetermined material contained in the functional liquid includes for example conductive materials, ferroelectric materials, semiconductor materials, dielectric materials and electric light emitting materials such as organic electroluminescence (EL) materials. Where the functional liquid contains a conductive material, a conductive pattern such as the lower electrode 22 and the upper electrode in the above-described embodiment can be obtained. Where the functional liquid contains a semiconductor material, a semiconductor pattern can be obtained. Where the functional liquid contains a dielectric material, a dielectric pattern can be obtained. Where the functional liquid contains a electric light emitting material, a electric light emitting pattern can be obtained.

D. Method for Manufacturing Stamp

### EXAMPLE 1

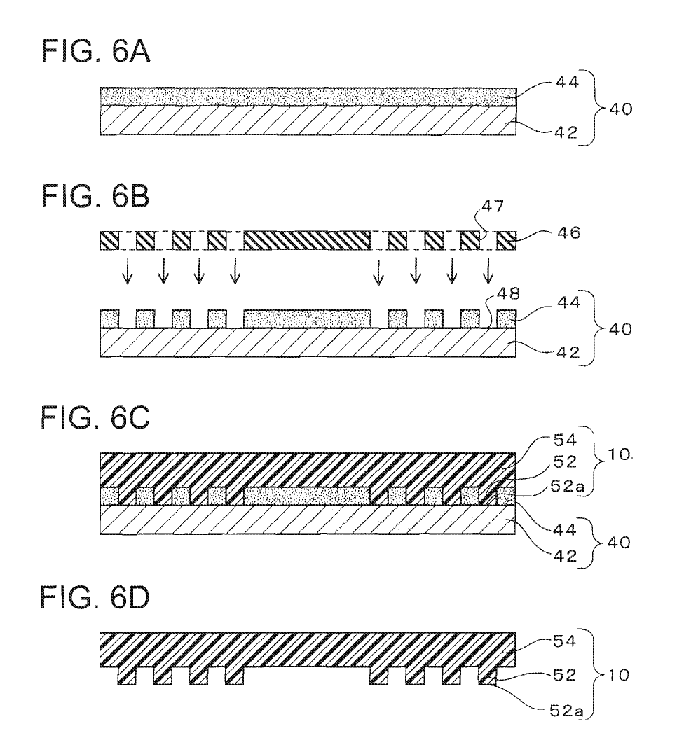

A method for manufacturing the stamp according to the embodiment of the invention will be now described. FIGS. 6-8 are explanatory drawings for describing the method for manufacturing the stamp according to the embodiment.

The stamp can be manufactured by pressing a base member made of PDMS or the like onto a master which is manufactured by photolithography and the like and molding it by heat. Firstly, Example 1 in which a stamp having the micron-sized apical face of the elastic element is manufactured by a photolithography method is hereunder described.

A master which is used for the formation of the stamp is manufactured in advance. Referring to FIG. 6A, a substrate 42 which is to be a base part of a master 40 is prepared. The substrate 42 is made of for example silicon. A photo-resist film 44 is formed on the upper face of the substrate 42. The photo-resist film 44 is formed by for example applying Photoresist S1811 in 1.7 μm thick by a spin, coating method and baking it at 90° C. for 30 minutes.

Referring to FIG. 6B, the photo-resist film 44 on the substrate 42 is then exposed by using a mask 46. The mask 46 is for example a positive mask which has a plurality of through-holes 471, each through-hole is provided with a gap of 1 μm and so as to form lines, each of the lines has a length of 20 μm. The shape of the opening of the through-hole is a rectangular 1 μm on a side. Following the exposure, the photo-resist film 44 is developed. Parts of the photo-resist film 44 corresponding to the through-holes 47 are removed by this development. Accordingly, holes 48 that expose the upper face of the substrate 42 are formed in the photo-resist film 44. Each hole 48 has an opening whose shape is the rectangular 1 μm on a side and each hole 48 is provided with a gap of 1 μm each other and to form lines, each of the line is 20 μm long. Developer FM-319 can be for example used to develop the photo-resist film 44. In the above-described way, the master 40 is obtained.

Next, a base member (unshown in the drawings) used for manufacturing the stamp 10 is prepared. The base member for the stamp 10 is for example a 2 μm thick plate made of PDMS. The base member for the stamp 10 is pressed onto the face of the master 40 on which the photo-resist film 44 has been formed and it is kept being pressed for an hour at 70° C. Though this process, elastic elements 52 each of which corresponds to each hole 48 and a base part 54 that has a face contacts with the upper face of the photo-resist film 44 are formed in the base member of the stamp 10. Each of the elastic elements 52 has an apical face 52a whose shape is a rectangular of 1 μm on a side. Each of the elastic elements 52 is provided with a 1 μm gap each other and so as to form lines, each of the line is 20 μm long.

Referring now to FIG. 6D, the stamp 10 on which the elastic elements 52 and the base part 54 have been formed is removed from the master 40, and the finished-stamp 10 is obtained.

D. Method for Manufacturing Stamp

### EXAMPLE 2

Secondly, Example 2 in which a high-resolution stamp having the submicron-sized or smaller than submicron-sized apical face of the elastic element is manufactured by a photolithography technique and a lift-off technique is hereunder described. Descriptions of the same structures or process as those of Example 1 will be hereunder omitted.

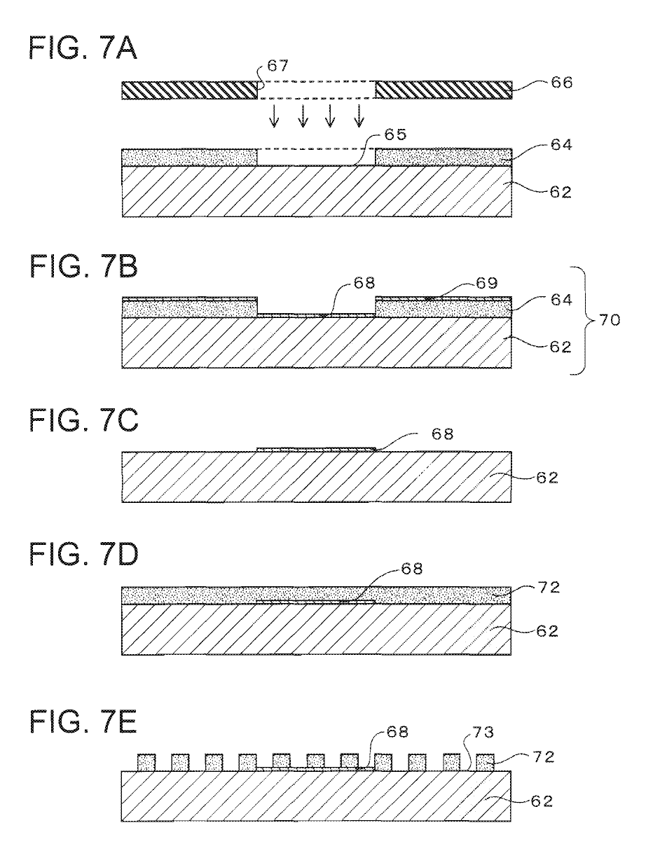

A master which is used for the formation of the stamp is manufactured in advance, Referring to FIG. 7A, a substrate 62 which is to be a base part of a master 60 is prepared. A photo-resist film 64 is formed on the upper face of the substrate 62. The photo-resist film 64 on the substrate 62 is then exposed by using a mask 66. The shape of a though-hole 67 in the mask 66 and the shape of a hole 65 which is formed corresponding to the though-hole 67 in the photo-resist film 64 correspond to a metal thin film 68 which will be formed in the following process.

Referring now to FIG. 7B, metal thin films 68, 69 are formed on the exposed face of the substrate 62 where the photo-resist film 64 has been removed and on the upper face of the photo-resist film 64. The metal thin films 68, 69 are for example made of aluminum. The metal thin films 68, 69 can be formed by for example a deposition method.

Subsequently, a structure 70 including the substrate 62, the photo-resist film 64 and the metal thin films 68, 69 is immersed into a solvent of the photo-resist film 64, though which is not shown in the drawings. At this point, the photo-resist film 64 is dissolved in the solvent and removed. Accordingly, the metal thin film 69 that exists on the photo-resist film 64 is removed. Consequently, the photo-resist film 64 and the metal thin film 69 that exists on the photo-resist film 64 are removed and only the metal thin film 68 remains on the substrate 62 as shown in FIG. 7C.

Referring to FIG. 7D, a photo-resist film 72 is formed on the upper faces of the substrate 62 and the metal thin film 68. The photo-resist film 72 can be formed by for example applying negative photo-resist THMR-iN PS1 in 200 nm thick by spin-coating and baking it at 90° C. for 90 seconds.

Referring now to FIG. 7E, a hole 73 which is provided in the plural number in the photo-resist film 72 is formed. The holes 73 are arranged for example in a lattice-like pattern in the diameter of 200 nm. The holes 73 are formed by performing en exposure using an interferometric lithography technique, baking at 100° C. for 90 seconds, and then developing.

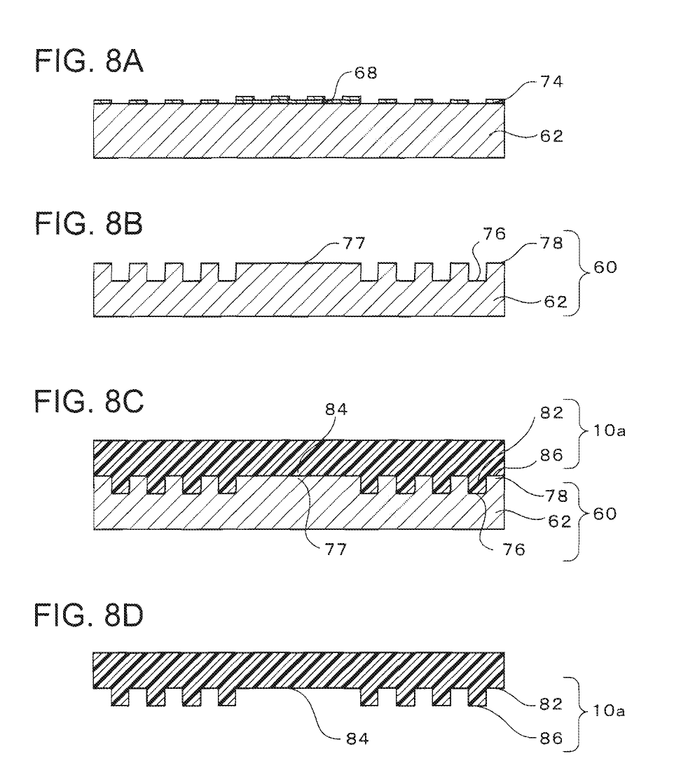

Referring to FIG. 8A, a dot 74 which is made of a metal thin film and provided in the plural number is formed on the upper faces of the substrate 62 and the metal thin film 68. The dots 74 are made of for example a 30 nm thick aluminum film. Each of the dots 74 corresponds to the hole 73 (see FIG. 7E). The dots 74 are arranged in a lattice-like pattern in 200 nm diameter on the upper faces of the substrate 62 and the metal thin film 68. A method of forming the dots 74 is now described. A metal thin film (unshown in( the drawings) is formed on the upper faces of the substrate 62, the metal thin film 68 and the photo-resist film 72 (see FIG. 7E) in the same manner as the formation of the metal thin film 68. Subsequently, this is immersed into the solvent of the photo-resist film 72, removing the photo-resist film 72 and the metal thin film formed on the photo-resist film 72. In this way, the dots 714 can be obtained.

Next, a part of the substrate 62 where is not covered with the metal thin film 68 or the dots 74 is etched. This etching of the substrate 62 can be performed by for example O₂+CF₄ plasma etching. The metal thin film 68 and the dots 74 on the substrate are removed in a KOH solution. In this way, the master 60 having a concave portion 76 which is formed by etching the substrate 62, a convex portion 77 which is the part remained where has been covered with the metal thin film 68, and convex portions 78 which are the part remained where have been covered with the dots 74 as shown in FIG. 8B. The convex portions 78 are arranged in a lattice-like pattern in the diameter of 200 nm.

Next, a base member (unshown in the drawings) used for manufacturing a stamp 10a is prepared. Referring to FIG. 8C, the base member for the stamp 10a is then pressed onto the forming face of the master 60 and it is kept being pressed for an hour at 70° C. Though this process, a convex portion 82 corresponding to the concave portion 76, a concave portion 84 corresponding to the convex portion 77, and concave portions 86 corresponding to the convex portions 78 are formed in the base member of the stamp 10a. The concave portions 86 are arranged in the lattice-like pattern in the diameter of 200 nm.

Referring to FIG. 8D, the stamp 10a in which the convex portion 82, the concave portion 84 and the concave portions 86 are formed is removed from the master 60, and the stamp 10a is obtained.

The method for manufacturing the stamp described in Example 1 can also be apply to the manufacturing of a stamp having a micron-level resolution.

According, to the method for manufacturing the stamp described in Example 2, the interferometric lithography technique which does not require a mask and can perform an exposure for a shorter time period is used. Therefore, it is possible to manufacture the stamp having nano or submicron scale-lattice, dots, holes and the like formed in a relatively large area at a lower cost compared with the method of Example 1.

E. Electronic Apparatus

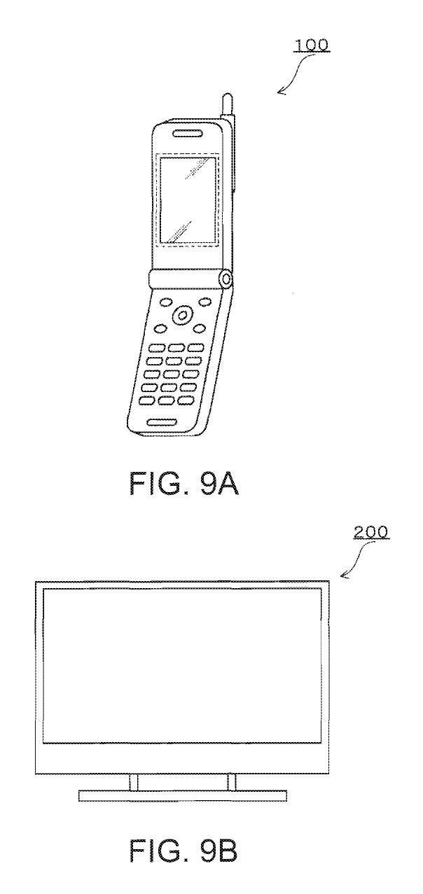

FIG. 9 shows an electronic apparatus according to an embodiment of the invention. The electronic apparatus according to an embodiment is for example a cell phone 100 as shown in FIG. 9A. The electronic apparatus according to other embodiment is for example a large-screen television set 200 as shown in FIG. 9B.

### MODIFICATIVE EXAMPLE 1

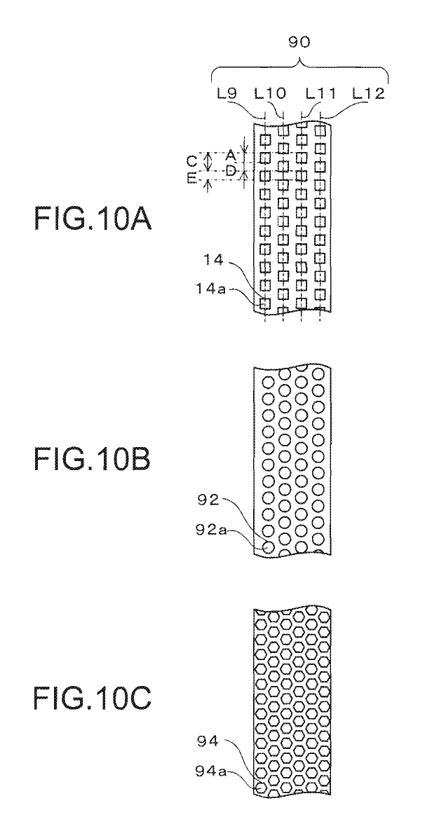

FIGS. 10A through 10C are explanatory drawings for modificative examples of the arrangement of the elastic elements of the stamp according to the embodiment.

Referring to FIG. 10A, the apical faces 14a forming a contact region 90 are arranged in a predetermined pitch “C” in the lines L9, L10, L11, L12. The two adjacent lines of the lines L9, L10, L11, L12 are placed such that its position differs by “E” in the extending direction. “E” is half of the predetermined pitch “C”. It is preferable that “E” be smaller than “A” which is the length of a side of the apical face 14a. Here, the distance “D” from one apical face 14a to the next apical face 14a (D=C−A) lies within a range of 0.1 A-10 A so that the predetermined pitch “C” should lie within a range of 1.1 A-2 A.

In this case, the dots which are formed on the object face 24 corresponding to the plurality of the apical faces 14a are arranged such that a dot in a line faces a gap between two adjacent dots in the next line. Thereby, even if the functional liquid flows over the gap between the dots in one line, the dot in the next line can prevent the functional liquid from further flowing. Therefore, with the surface energy difference bank in which the dots are arranged in this way, it is possible to effectively prevent the flowing out of the functional liquid across the dots.

FIG. 10B shows the case where a shape of an apical face 92a of an elastic element 92 which is provided in the plural number is a circle. FIG. 10C shows the case where a shape of an apical face 94a of an elastic element 94 which is provided in the plural number is a hexagon. The shape of the apical face 92a may be any figure other than a rectangular.

### MODIFICATIVE EXAMPLE 2

Though the O₂ plasma treatment or the CF₄ plasma treatment is performed as a surface treatment in the above-described embodiments, a corona discharge treatment, an UV ozone treatment, a chemical reaction treatment, coating, a vacuum deposition or the like can be performed as the surface treatment instead of the plasma treatment.

### MODIFICATIVE EXAMPLE 3

In the process of the formation of the lower electrode 22, the PMMA layer is embossed by using the silicon chip having a plurality of grooves in order to form the plurality of the grooves according to the above-described embodiments. However, photolithography, an interferometric lithography, a micro-contact printing, an off-set printing or the like can be performed instead of the embossing.

### MODIFICATIVE EXAMPLE 4

Though the ink-jet printing method is adopted to form the lower electrodes 22 in the above-described embodiments, a resist patterning and lift-off method, an electroless plating method, a micro-cutting method, a micro/nano-probe writing method or the like con be adopted instead of the ink-jet printing method.

### MODIFICATIVE EXAMPLE 6

Either a solution or a colloidal suspension can be used as the material which is printed by the ink-jet printing method. Either an organic material or an inorganic material can be used as the conductive material. For example, polyethylenedioxy thiophene (PEDOT), polyaniline, gold, nickel, copper, carbon or the like can be used.

### MODIFICATIVE EXAMPLE 6

The above-described manufacturing methods can be applied to either a “sheet-to-sheet method” or a “roll-to-roll method”. The material for forming the substrate can be flexible or solid. For example, polyethylene-naphthalate (PEN), polyethylene terephthalate (PET), poly-carbonate (PC), poly-ethersulphone (PES), polyetherketone (PEEK: registered trademark) or the like can be used as the material of the substrate.

The invention is obviously not limited to the specific embodiments described herein, but also encompasses any variations that may be considered by any person skilled in the art, within the general scope of the invention. Note that the invention encompasses the substantially same elements and components as those described in the above-described embodiments (for example, a structure resulting in the same function, method or effect, or a structure having the same purpose or result). The invention also encompasses the structure in which unessential part of the structure described in the above embodiments is replaced by other element. The invention also encompasses the constructions that serve the equivalent function and exert the equivalent effect and the constructions that can achieve the same objective as those of the embodiments. The invention also encompasses the structure in which a hitherto know art is added to the structure described in the above embodiments.

The entire disclosure of Japanese Patent Application No. 2006-195190, filed Jul. 18, 2006, is expressly incorporated by reference herein.

What is claimed is:

1. A method for forming a structure, comprising:
providing a material onto each of a plurality of apical faces of at least some of a plurality of protruding portions protruding out from a base part of the stamp; and
transferring the material from the each of a plurality of the apical faces to an object face by contacting the each of a plurality of the apical faces with the object face to form a plurality of dots on the object face, each of the plurality of the dots including the material and corresponding to at least some of the plurality of protruding portions.

2. The method of forming a structure according to claim 1, the plurality of protruding portions including a plurality of elastic elements.

3. The method of forming a structure according to claim 2, the plurality of apical faces of the plurality of the protruding portions being the plurality of apical faces of the plurality of the elastic elements.

4. The method of forming a structure according to claim 1, the object face having an uneven surface, and each of the plurality of the protruding portions deforming according to convex-concave figure of the object while contacting the contact region with the object face.

5. The method of forming a structure according to claim 1, the plurality of the apical faces being arranged in such a way that the plurality of the dots formed on the object face prevents a functional liquid from flowing over the plurality of the dots.

6. The method of forming a structure according to claim 5, the plurality of the apical faces being arranged so as to form lines.

7. The method of forming a structure according to claim 6, the apical faces being arranged in a predetermined pitch in each of the lines, and any two adjacent lines among the lines are arranged such that; the two lines are out of alignment each other by substantially a half of the predetermined pitch in a column-direction in which the lines extend.

8. The method of forming a structure according to claim 1, the material including a plurality of molecules that bond to another plurality of molecules composing a surface of the object face to form a self assembled molecular film on the object face, the self-assembled molecular film included in at least one of the plurality of the dots.

9. The method of forming a structure according to claim 8, the self-assembled molecular film being more liquid-repellent than the object face.

10. The method of forming a structureaccording to claim 8, the self-assembled molecular film being more hydrophilic than the object face.

11. A bank structure manufactured by the method of forming a structure according to claim 1.

12. An electronic circuit, comprising:
a bank structure manufactured by the method of forming a structure according to claim 11; and
at least one of a conductive pattern, a ferroelectric pattern, a semiconductor pattern, a dielectric pattern or an electric light emitting pattern which is formed in the area defied by the surface energy difference bank.

13. An electronic device, comprising:
a bank structure manufactured by the method of forming a structure according to claim 1; and
at least one of a conductive pattern, a ferroelectric pattern, a semiconductor pattern, a dielectric pattern or an electric light emitting pattern which is formed in the area defied by the surface energy difference bank.

14. An electronic apparatus, comprising;
a bank structure manufactured by the method of forming a structure according to claim 1; and
at least one of a conductive pattern, a ferroelectric pattern, a semiconductor pattern, a dielectric pattern or an electric light emitting pattern which is formed in the area defied by the surface energy difference bank.
